(19) United States
(12) Patent Application Publication
(10) Pub. No.: US 2020/0173496 A1
(43) Pub. Date: Jun. 4, 2020

(54) BEARING HOUSING FOR A TURBOMACHINE, AND TURBOMACHINE HAVING A BEARING HOUSING

(71) Applicant: Sulzer Management AG, Winterthur (CH)

(72) Inventor: Andreas WILD, Bruchsal (DE)

(21) Appl. No.: 16/621,478

(22) PCT Filed: Jun. 27, 2018
(86) PCT No.: PCT/EP2018/067231

§ 371 Date: Dec. 11, 2019

(30) Foreign Application Priority Data
Jun. 28, 2017 (EP) 17178376.4

(51) Int. Cl. F16C 37/00; F16C 33/66

(52) U.S. Cl. CPC F16C 37/007; F16C 2360/44; F16C 33/6666

(57) ABSTRACT

A bearing housing for a flow machine includes a bearing axis, a bearing chamber, a lubricant chamber and internal cooling fins. The bearing chamber is configured to receive a bearing. The lubricant chamber is configured to receive a lubricant. The lubricant chamber and the bearing chamber are in flow communication via an opening. The lubricant chamber includes a wall portion configured to dissipate heat to the environment, and the wall portion has an inner surface directed towards the lubricant chamber and an outer surface directed towards the environment. The internal cooling fins are arranged at a part of the inner surface.

### CROSS-REFERENCE TO RELATED APPLICATION

This application is a U.S. National Stage application of International Application No. PCT/EP2018/067231, filed Jun. 27, 2018, which claims priority to European Patent Application No. 17178376.4, filed Jun. 28, 2017, the contents of each of which are hereby incorporated herein by reference.

### BACKGROUND

### Field of Invention

The invention relates to a bearing housing for a flow machine. The invention further relates to a flow machine with a bearing housing.

### Background Information

Conventional flow machines for conveying a fluid, for example centrifugal pumps, compressors, fans, expanders or turbines typically comprise a stationary machine housing that encloses a rotor, e.g. an impeller, which is arranged on a shaft rotating around an axis of the flow machine. The flow machine generally also has at least one bearing unit with a radial and/or axial (thrust) bearing to support the shaft and the rotor. Typically, the bearing unit has a separate bearing housing that is firmly connected to the housing of the flow machine. In this case, the bearing housing comprises a beating axis, a bearing chamber for receiving the bearing and a lubricant chamber for receiving a lubricant. The lubricant chamber and the bearing chamber are in flow communication via an opening, so that the bearing can be cooled and lubricated by the lubricant during operation of the flow machine. Furthermore, the lubricant chamber has a wall portion for dissipating heat to the environment, wherein the wall portion has both an inner surface directed towards the lubricant chamber and an outer surface directed towards the environment.

In order to dissipate the frictional heat generated in the bearing during operation of the flow machine, external cooling fins can be attached to the outer surface of the bearing housing known from the state of the art and/or the bearing housing is cooled by a fan to support heat dissipation. In another way, cooling can also be achieved by water or by increasing the size of the lubricant chamber and/or by increasing the amount of lubricant.

### SUMMARY

It has been determined that, in practice, under certain operating conditions, e.g. high outside air temperatures above 50° C., the cooling techniques mentioned are insufficient and expensive, resulting in an increased wear or even bearing failure or high bearing housing costs.

Accordingly, it is an object of the invention to improve a bearing housing in such a way that sufficient cooling of the bearing and the lubricant can be achieved even at high ambient temperatures, and thus the ambient temperature range for the operation of the flow machine can be extended.

The objects of the invention meeting this problem are characterized by the embodiments disclosed herein.

Thus, in one embodiment, the invention relates to a hearing housing for a flow machine, wherein the bearing housing comprises a bearing axis, a bearing chamber for receiving a bearing and a lubricant chamber for receiving a lubricant, wherein the lubricant chamber and the bearing chamber are in flow communication via an opening, and wherein the lubricant chamber comprises a wall portion for dissipating heat to the environment, and which wall portion has an inner surface directed towards the lubricant chamber and an outer surface directed towards the environment.

According to the invention, internal cooling fins are arranged at a part of the inner surface.

Therefore, the bearing housing according to the invention has cooling fins in the lubricant chamber, which cooling fins increase the total surface area of the lubricant chamber, which is available for the heat exchange between the lubricant and the wall portion for the dissipation of heat to the environment.

This makes it possible to achieve sufficient cooling of the bearing and the lubricant even at high ambient temperatures and thus to expand the ambient temperature range for the operation of the flow machine. This ensures sufficient lubrication and cooling even at outside air temperatures above 50° C., which can increase the service life of the bearing.

In a preferred embodiment, the lubricant chamber is filled with the lubricant up to a lubricant level in the operating state and the internal cooling fins extend completely below the lubricant level. As a result, the contribution of the internal cooling fins for heat exchange is particularly effective.

In a particularly preferred embodiment, the internal cooling fins extend in the direction of the bearing axis. As a result, the production of the bearing housing is particularly simplified.

Alternatively, it is also possible, that the internal cooling fins extend in the circumferential direction with respect to the bearing axis. This also simplifies the production of the bearing housing.

In addition, it is also possible, that the internal cooling fins extend spirally with respect to the bearing axis. This results in improved circulation of the lubricant in the lubricant chamber, whereby a more effective heat exchange can be achieved.

It has also proven to be advantageous if the opening is formed as a slot. This results in an improved supply of lubricant into the bearing chamber. Preferably, the slot extends in the direction of the hearing axis.

In a preferred embodiment, all internal cooling fins are arranged parallel to each other.

It is also advantageous if all internal cooling fins are arranged below the lubricant chamber.

It is a preferred measure that each internal cooling _fin is designed in such a way that it has a substantially rectangular cross-sectional area in a section perpendicular to the bearing axis.

In a preferred embodiment, each internal cooling fin extends from the inner surface of the lubricant chamber in the vertical direction in each case.

In practice, it has also proven to be advantageous if external cooling fins are additionally arranged at a part of the outer surface. This increases the overall surface area available for heat exchange between the bearing housing and the environment.

The invention also relates to a flow machine with the bearing housing according to the invention. Here, the flow machine may be a pump, in particular a centrifugal pump.

### BRIEF DESCRIPTION OF THE DRAWINGS

The invention will be explained in more detail hereinafter with reference to the drawings.

FIG. 1 is a sectional view of a flow machine according to the invention,

FIG. 2 is a perspective view of a first embodiment of a bearing housing according to the invention,

FIG. 3 is a perspective view of a second embodiment of a bearing housing according to the invention, and

FIG. 4 is a view of the second embodiment in the direction of the bearing axis.

### DETAILED DESCRIPTION OF THE EMBODIMENTS

In the following description, reference is made by way of example to an important application, namely that the flow machine is designed as a centrifugal pump.

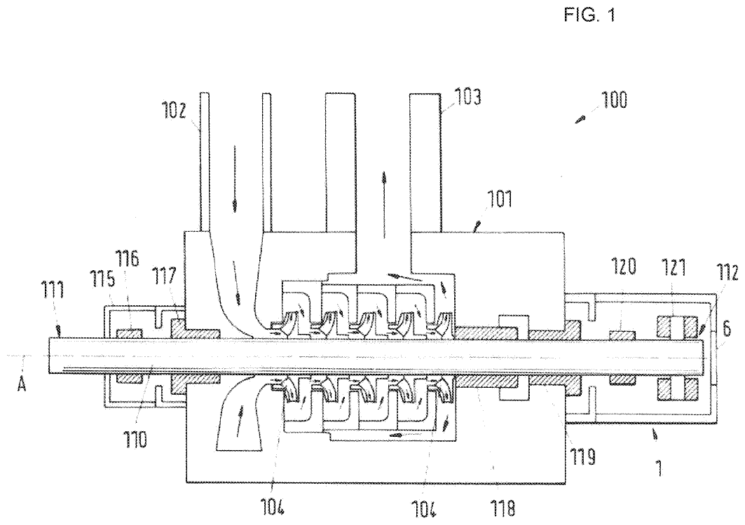

FIG. 1 shows a sectional view of an embodiment of a flow machine according to the invention, which is referred to in its unit with the reference sign 100. The embodiment of the flow machine 100 is a centrifugal pump 100 for conveying a fluid, for example water or crude oil or a multiphase liquid. It is clear, that the invention is neither limited to the centrifugal pump 100 shown in FIG. 1, nor to centrifugal pumps as such, but it refers to flow machines 100 in general. For example, the flow machine 100 may also be another type of pump, a compressor, a fan, an expander or a turbine.

The centrifugal pump 100 comprises a housing 101, which may include a plurality of housing parts, which are connected to each other to form the housing 101. The housing 101 of the centrifugal pump 100 comprises an inlet 102, through which the fluid to be conveyed enters the pump 100 and an outlet 103 for discharging the fluid. At least one impeller 104 is disposed inside the housing 101 to convey the fluid. The centrifugal pump illustrated in FIG. 1 is designed as a multi-stage pump with several impellers 104, for example five impellers 104. All impellers 104 are arranged in a row on a shaft 110 in a torque-proof manner. During operation of the pump, the impellers 104 are rotated by the shaft 110 about an axial direction A, which is defined by the longitudinal axis of the shaft 110. The flow of the fluid is indicated in FIG. 1 by the arrows without a reference sign.

The shaft 110 is driven by a drive unit, not shown here, for example, an electric motor or any other motor, to which the shaft 110 is coupled. The end of the shaft 110 coupled to the drive unit is referred to as the drive end 111 of the shaft, while the other end of the shaft 110 is referred to as the non-drive end 112. According to the illustration in FIG. 1, the drive end 110 connected to the drive unit (not shown) is on the left side.

The pump 100 comprises the following components starting from the drive end 111 of the shaft 110 and to the direction of the non-drive end 112: a drive end bearing housing 115 receiving a radial (or bearing journal) bearing 116; a mechanical sealing 117 for sealing the pump 100 against leakage of the fluid along the shaft 110; the plurality of the impellers 104; a relief piston 118 for compensating the axial thrust generated by the impellers 104; another mechanical sealing 119 for sealing the non-drive side of the shaft 110 against leakage of the fluid to be conveyed; and a non-drive end bearing housing 1 receiving another radial (or journal-shaped) bearing 120, and a thrust (or axial) bearing 121 for supporting the non-drive end 112 of the shaft 110 with respect to the radial direction and the axial direction A.

Thus, the centrifugal pump 100 includes bearings 116, 120, 121 on both sides of the plurality of impellers 104, in this example at the drive end 111 of the shaft 110 and at the non-drive end 112 of the shaft 110.

The bearing housing 115 arranged at the drive end 111 of the shaft 110 is designed according to the invention. Of course, the bearing housing according to the invention may also be provided at the non-drive end 112 or also at both ends of the centrifugal pump 100, i.e. at the drive end 111 and at the non-drive end 112.

The centrifugal pump 100 according to FIG. 1 has a thrust (or axial) bearing 121 as mentioned above. The bearing housing according to the invention is also particularly suitable for pumps without a thrust (or axial) bearing. These pumps have a two-part relief device instead of the relief piston 118 (Fig.1) for axial thrust compensation comprising a co-rotating relief disc and a fixed relief counter-disc, which form a gap extending in the radial direction, through which gap a part of the fluid being under pressure in the pump is discharged to the outside. In doing so, the shaft of the pump is kept in a state of equilibrum in the axial direction between the force generated by the axial thrust and the counterforce generated by the relief device. In contrast to the relief piston 118, the relief device is “self-regulating” and compensates the entire axial thrust, so that no separate axial bearing is required at the pump.

The bearing housing 115 will now be explained in more detail with reference to an embodiment of the bearing housing 115 for receiving the drive end 111 of the shaft 110.

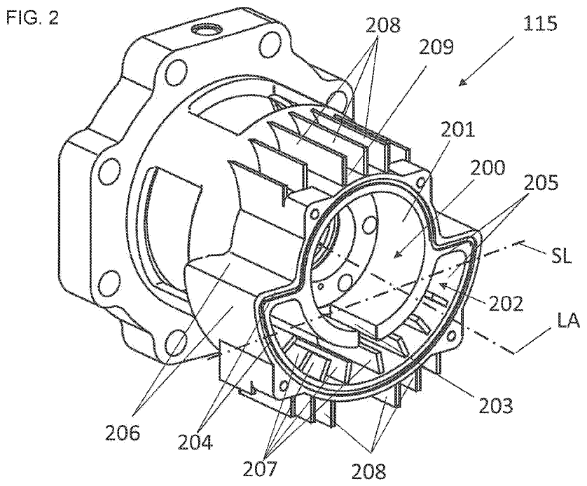

FIG. 2 shows a perspective view of a first embodiment of the bearing housing 115 according to the invention for receiving the drive end 111 of the shaft 110 of the flow machine 100. The hearing housing 115 comprises a hearing axis LA, a bearing chamber 200 with a bearing chamber surface 201 for receiving a bearing (not shown) and a lubricant chamber 202 for receiving a lubricant. In this embodiment, the lubricant chamber 202 encloses the bearing chamber 200 partially tubular, i.e. the lubricant chamber 202 has a U-shaped cross-section. The radially outer wall, which delimits the U-shaped lubricant chamber 202, is essentially designed as a ring segment and is arranged coaxially with the bearing chamber 200. This means that the lubricant chamber 202 surrounds about half of the essentially cylindrical bearing chamber 200 radially on the outside. The lubricant chamber 202 extends below the bearing chamber 200. The lubricant chamber 202 and the bearing chamber 200 are in flow communication via an opening, so that the bearing can be cooled and lubricated by the lubricant during operation of the flow machine.

Since the lubricant chamber 202 is arranged below the bearing chamber 200, gravitation supports the collection of lubricant in the lubricant chamber 202. The lubricant chamber 202 with the lubricant therein thus functions as a lubricant bath, for example as an oil bath, for the hearing arranged (not shown) in the bearing chamber 200.

In this embodiment, the opening 203 is formed as a slot 203 extending in the direction of the bearing axis LA. In addition, the lubricant chamber 202 has a wall portion 204 for dissipating heat to the environment, wherein the wall portion 204 has both a surface 205 directed towards the lubricant chamber 202 and an outer surface 206 directed towards the environment.

According to the invention, in the bearing housing 115, internal cooling fins 207 are arranged at a part of the inner surface 202 of the lubricant chamber 202. The internal cooling fins 207 are perpendicular to the inner surface 205 of the lubricant chamber 202 and extend in the direction of the bearing axis LA. In this embodiment, each internal cooling fin 207 is designed such that it has a substantially rectangular cross-sectional area in a section perpendicular to the bearing axis LA, wherein the extension in the radial direction is significantly greater, and is at least greater by a factor of 2 than in the direction perpendicular thereto. The internal cooling fins 207 are preferably all arranged below the bearing axis LA and in particular below the bearing chamber 200, wherein the term “below” refers to the nominal position of use. FIG. 2 shows the bearing housing 115 in its normal position of use.

The lubricant chamber 202 is filled with the lubricant up to a lubricant level SL in the operating state. Both the slot 203 and the internal cooling fins 207 extend below the lubricant level SL, i.e. they are completely covered by lubricant. Furthermore, the bearing housing 115 has external cooling fins 208. These are attached both to the outer surface 206 of the lubricant chamber 202 and to the outer surface 209 of the bearing chamber 200.

The bearing housing 115 with the internal cooling fins 207 and the external cooling fins 208 are preferably produced using casting technology. This means that the bearing housing 115 is preferably designed as a casting, whereby the internal cooling fins 207 and the external cooling fins 208 are designed in one piece as an integral part of the bearing housing 115. The bearing housing 115 inclusive of the internal cooling fins 207 and the external cooling fins 208 is therefore preferably produced in a casting process. In this respect, the number of internal cooling fins 207 or external cooling fins 208, their respective distance from each other and their specific design can also be determined under the criterion that the bearing housing 115 should be possible to produce using casting technology.

With regard to cooling the lubricant as efficiently as possible, it is preferred if at least four, and particularly preferred at least six internal cooling fins 207 are provided, which are preferably all arranged below the bearing chamber 200 in the lubricant chamber. In the embodiment represented in FIG. 2, a total of eight internal cooling fins are provided.

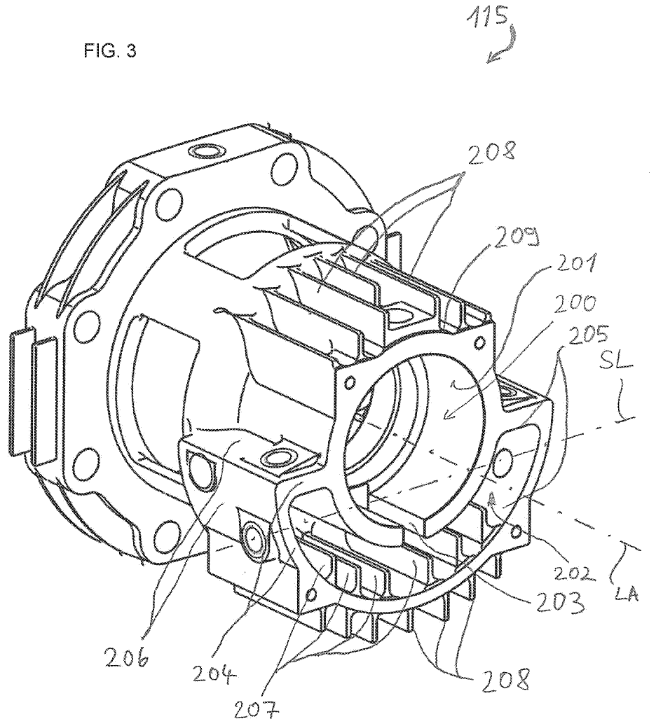

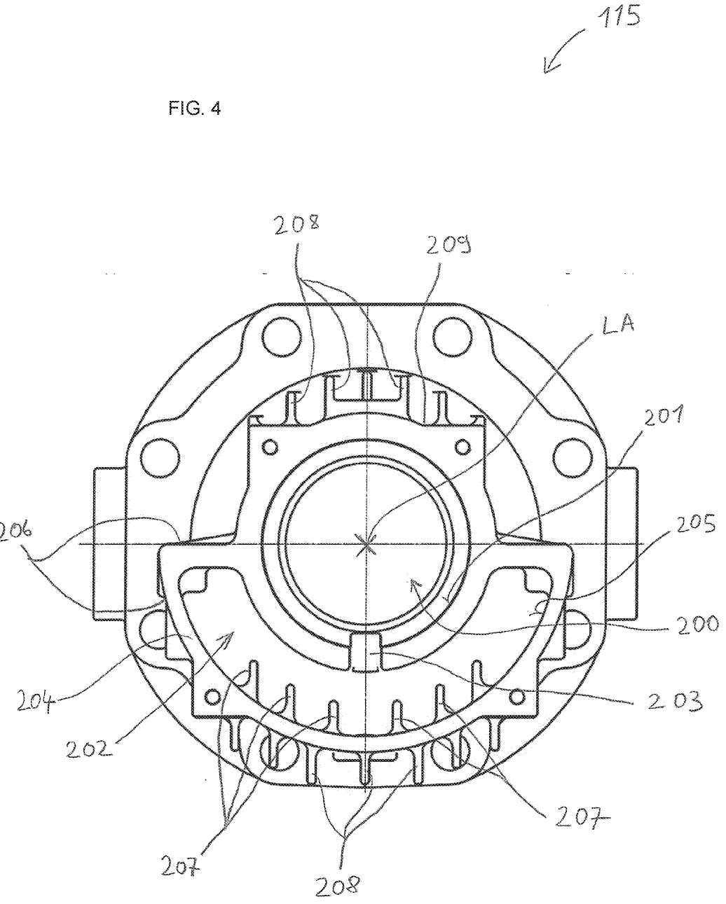

In the following, a second embodiment of the bearing housing 115 according to the invention is explained with reference to FIG. 3 and. FIG. 4. In this embodiment, only the differences from the first embodiment will be discussed. The same parts or functionally equivalent parts of the second embodiment are designated with the same reference signs as in the first embodiment. In particular, the reference signs have the same meaning as they are already explained in connection with the first embodiments. It is understood that all the above explanations of the first embodiment also apply in the same manner or in accordingly the same manner to the second embodiment.

FIG. 3 shows a perspective view of the second embodiment of a beating housing 115 according to the invention, and FIG. 4 shows a view of the second embodiment, wherein the viewing direction is the direction of the bearing axis LA. As already in FIG. 2 and FIG. 3, the bearing cover is also removed in FIG. 4, which at least closes the lubricant chamber 202 of the bearing housing 115 with respect to the axial direction A, in order to allow a view into the bearing housing 115.

In contrast to the first embodiment, in the second embodiment the internal cooling fins 207 are no longer arranged in the radial direction, but extend in each case from the inner surface 205 of the lubricant chamber 202 upwards in the vertical direction, so that all internal cooling fins 207 run parallel to each other. The internal cooling fins 207 all extend therefore parallel to each other in the direction of the bearing axis LA.

Furthermore, each internal cooling fin 207 is again designed in such a way that it has a substantially rectangular cross-sectional area in a section perpendicular to the bearing axis, wherein the extension in the vertical direction is significantly greater, and is at least greater by a factor of 2 than in the direction perpendicular thereto. The term “substantially rectangular” cross-sectional area means that the corners or edges can be rounded in each case, as can be seen in particular in FIG. 4. Furthermore, the transitional area between the respective internal cooling fin 207 and the inner surface 205 of the lubricant chamber may also be rounded, in particular for reasons of production technology.

The distance between adjacent parallel internal cooling fins 207 can vary, i.e. the internal cooling fins 207 do not have to be arranged equidistantly. As FIG. 4 shows, for example, the distance between the two middle internal cooling fins 207, i.e. those arranged at the lowest position in the lubricant chamber 202, is significantly greater than the distance between other adjacent internal cooling fins 207. For reasons of production technology, it is preferred if the distance between two respectively adjacent parallel internal cooling fins 207 is at least 20 mm.

The height of the internal cooling fins 207, i.e. their extension in the vertical direction, is at least approximately the same for all internal cooling fins 207.

In the second embodiment, a total of six internal cooling fins 207 are provided. The height, the number, the specific design of the internal cooling fins 207 and the distance between adjacent internal cooling fins 207 are optimized under the aspects that sufficient heat dissipation is to be achieved from the lubricant, that the internal cooling fins 207 should be as easy to produce as possible in terms of production technology, in particular in terms of casting technology, and that there is sufficient mixing of the lubricant in the lubricant chamber 202, so that the formation of layers of lubricants of different temperatures in the lubricant chamber 202 is avoided as far as possible.

1. A bearing housing for a flow machine, bearing housing comprising:
a bearing axis;
a bearing chamber configured to receive a bearing;
a lubricant chamber configured to receive a lubricant,
the lubricant chamber and the bearing chamber in flow communication via an opening, the lubricant chamber comprising a wall portion configured to dissipate heat to an environment, and the wall portion has having an inner surface directed towards the lubricant chamber and an outer surface directed towards the environment; and
internal cooling fins arranged at a part of the inner surface.

2. The bearing housing according to claim 1, wherein the lubricant chamber is configured to be filled with the lubricant up to a lubricant level in an operating state, and the internal cooling fins extend completely below the lubricant level.

3. The bearing housing according to claim 1, wherein the internal cooling fins extend in a direction of a bearing axis.

4. The bearing housing according to claim 1, wherein the internal cooling fins extend in a circumferential direction with respect to a bearing axis.

5. The bearing housing according to claim 1, wherein the internal cooling fins extend spirally with respect to a bearing axis.

6. The bearing housing according to claim 1, wherein the opening is a slot.

7. The bearing housing according to claim 6, wherein the slot extends in a direction of a bearing axis.

8. The bearing housing according to claim 1, wherein all of the internal cooling fins are arranged parallel to each other.

9. The bearing housing according to claim 1, wherein all of the internal cooling fins are arranged below the lubricant chamber.

10. The bearing housing according to claim 1, wherein each internal cooling fin of the internal cooling fins has a substantially rectangular cross-sectional area in a section perpendicular to a bearing axis.

11. The bearing housing according to claim 1, wherein each internal cooling fin of the internal cooling fins extends from the inner surface of the lubricant chamber in a vertical direction.

12. The bearing housing according to claim 1, further comprising external cooling fins disposed at a part of the outer surface.

13. A flow machine, comprising:
the bearing housing according to claim 1.

14. The flow machine according to claim 13, wherein the flow machine is a pump.

15. The flow machine according to claim 13, wherein the flow machine is a centrifugal pump.
